(19) United States
(12) Patent Application Publication
(10) Pub. No.: US 2011/0004654 A1
(43) Pub. Date: Jan. 6, 2011

(54) DEVICE MANAGEMENT SESSION TRIGGER

(75) Inventors: Mikko Jarkko Oskari Tasa, Tampere (FI); Jukka Tapani Partanen, Lempaala (FI); Thinh Nguyenphu, Southlake, TX (US)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/644,424

(22) Filed: Dec. 22, 2009

Related U.S. Application Data
(60) Provisional application No. 61/140,048, filed on Dec. 22, 2008.

(51) Int. Cl. G06F 15/16; G06F 9/00

(52) U.S. Cl. 709/203; 713/2

(57) ABSTRACT

A system and method for initiating a Device Management (DM) session between a client and a server. More particularly, a system and method for triggering an Open Mobile Alliance (OMA) DM client which does not support User Data Protocol (UDP) PUSH messaging to initiate a DM session with an OMA DM server. The OMA DM client may be triggered by configuring a service provider node to include an indicator in a Hypertext Transfer Protocol (HTTP) response message sent from a service provider node to the OMA DM client. Upon reception of the last HTTP response message, the OMA DM client may initiate a DM session with a OMA DM server and thereby receive initial provisioning data from the OMA DM server. Alternatively, the OMA DM server and OMA DM client may maintain a previously created DM session and thereby receive the initial provisioning data.

### RELATED APPLICATION

This application claims priority to U.S. Application No. 61/140,048 filed Dec. 22, 2008, which is incorporated herein by reference in its entirety.

### FIELD OF THE INVENTION

The present invention is generally related to device management (DM). More particularly, the present invention relates to initiating a DM session between a client and a server.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Worldwide Interoperability for Microwave (WiMAX) is a broadband wireless access solution which provides for the wireless transmission of data using a variety of transmission modes, from point-to-point links to full mobile cellular access. WiMAX technology is based upon the Institute of Electronic and Electronics Engineers (IEEE) 802.16 suite of standards and enables the delivery of wireless broadband services anytime, anywhere. WiMAX products can accommodate fixed, portable, and mobile usage models.

WiMAX is promoted and certified by the WiMAX Forum, a special interest group comprising members of the manufacturing, carrier, and service communities. The WiMAX Forum was formed to develop technical specifications and certify compatibility/interoperability of broadband wireless products using the IEEE 802.16 suite of standards. Based on requirements from the Server Provider Working Group (SPWG) of the WiMAX Forum, the Network Working Group (NWG) of the WiMAX Forum develops end-to-end, all-IP system specifications for WiMAX networks. These WiMAX networks support both stationary and fully mobile operation based on the IEEE 802.16 suite of standards.

Open Mobile Alliance (OMA) is a standardization forum. OMA facilitates global user adoption of mobile data services by specifying market driven mobile service enablers that ensure service interoperability across devices, geographies, service providers, operators, and networks, while allowing businesses to compete through innovation and differentiation.

One particular area of OMA standardization is related to DM. In this area, OMA has produced a DM specification referred to as OMA DM. OMA DM is designed to support management of provisioning, device configuration, software upgrades, and fault management. OMA DM is an extensible and well defined XML (extended Markup Language) based data transfer protocols which can be used to manage a diverse set of settings in the mobile devices.

### SUMMARY

Various embodiments provide a systems and methods for initiating a DM session between a client and a server. More particularly, various embodiments provide a trigger to initiate a DM session between an OMA DM server and an OMA DM client.

Various embodiments provide a method, computer-program product, and device for receiving an acceptance message concerning an acceptance of a subscription plan from a user terminal associated with the service provider node. The acceptance message concludes an ordering subscription procedure conducted between the service provider node and the user terminal. In response to receiving the acceptance message, a response message is created including a predetermined identifier in the response message. The predetermined identifier is configured to trigger an initiation action by the user terminal upon receipt and subsequent processing by the user terminal. The response message is transmitted from the service provider node to the user terminal and includes the predetermined identifier in the response message.

Various embodiments also provide a method, computer-program product, and device for transmitting an acceptance message concerning a subscription plan to a service provider node. The acceptance message concludes an ordering subscription procedure being conducted with the service provider node. Subsequently, a response message comprising a predetermined identifier in the response message is received from the service provider node. The predetermined identifier is configured to trigger an initiation action upon receipt and subsequent processing. In response to receipt and subsequent processing of the predetermined identifier within the response message, a management session is initiated with a server.

Various embodiments further provide a method, computer-program product, and device for conducting a client-initiated bootstrap procedure with a user terminal. Upon completion of the client initiated bootstrap procedure, the user terminal is queried in a device management session for user terminal information. This device management session is maintained with the user terminal after completion of the query. The user terminal information is provided to a service provider node and a management provision request is received from the service provider node. At this point, initial provisioning data is sent to the user terminal using the device management session.

The features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

Embodiments of the invention are described by referring to the attached drawings, in which:

FIG. 1 is a signaling diagram of an exemplary implementation of various embodiments;

FIG. 2 shows an exemplary HTTP response message;

FIG. 3 is a flow chart showing an exemplary implementation of various embodiments;

FIG. 4 is a signaling diagram of an exemplary implementation of various embodiments;

FIG. 5 is a flow chart showing an exemplary implementation of various embodiments;

FIG. 6 is a perspective view of an electronic device that can be used in conjunction with the implementation of various embodiments; and

FIG. 7 is a schematic representation of the circuitry which may be included in the electronic device of FIG. 6.

### DETAILED DESCRIPTION OF VARIOUS EMBODIMENTS

Various embodiments provide a system and method for initiating a DM session between an OMA DM client and an OMA DM server. As defined by the WiMAX forum, “DM” is the process of remotely managing device settings and applications. DM provides a mechanism for the users to easily subscribe to new services and make changes to their existing services. For the operators, this enables a fast and easy way to introduce new services and manage provisioned services by dynamically adjusting to changes and ensuring a certain level of quality of service.

As defined by the WiMAX forum, “OMA DM” refers to the set of specifications developed by OMA for DM. The “client” or “provisioning client” is defined as an agent in the device that is an extension of the provisioning protocol to support WiMAX requirements. The client is subsequently referred to as “OMA DM client” or “client.” As further defined by the WiMAX forum, the “server” or “provisioning server” is a management authority that has the right to perform a specific device management function on a device or to manipulate a given data element or parameter. The server is subsequently be referred to as the “OMA DM server” or “server.”

An OMA DM session between a OMA DM client and a OMA DM server may initiated one of two ways. The session may either be (1) initiated by an OMA DM server or (2) initiated by an OMA DM client. If the OMA DM server initiates the OMA DM session, the OMA DM server pushes a message to the device via User Data Protocol (UDP) PUSH. The UDP PUSH message comprises information which informs the OMA DM client to initiate a DM session. In response to receiving this message, the OMA DM client may initiate a DM session with the OMA DM server. However, not all OMA DM clients support such server-initiated messaging processes. For example, electronic devices such as laptops, PDAs, and desktops often have firewalls which prevent the reception of UDP PUSH messages or other types of server-initiated messages. Therefore, if a UDP PUSH message were transmitted from a OMA DM server to one of these devices, the firewall of the OMA DM client would likely prevent reception of the UDP PUSH message, and therefore the OMA DM server would not be able to trigger the OMA DM client to initiate a OMA DM session. As such, these types of devices must initiate an OMA DM session themselves (i.e., not in response to receiving a server-initiated message such as a UDP PUSH message).

In the context of WiMAX, the client-initiated procedure for initiating an OMA DM session with an OMA DM server is referred to as WiMAX Specific Client-Initiated Bootstrap (WIB). WIB, as defined by the WiMAX forum, is a procedure which enables the discovery and negotiation of the DM OTA protocol to be used between the device and the network. The procedure comprises WIB server discovery using Domain Name System (DNS) and WIB Over the Air (OTA) protocol negotiation using simple HTTP between the device and the WIB server.

Various embodiments provide a system and method to trigger an OMA DM client which supports WIB to initiate a DM session with a OMA DM server. More particularly, various embodiments trigger an OMA DM client to initiate a DM session by incorporating a particular header in a HTTP response message sent from a service provider node to the device. Upon receiving and processing this HTTP response message, the OMA DM client is triggered to initiate a DM session with the OMA DM server.

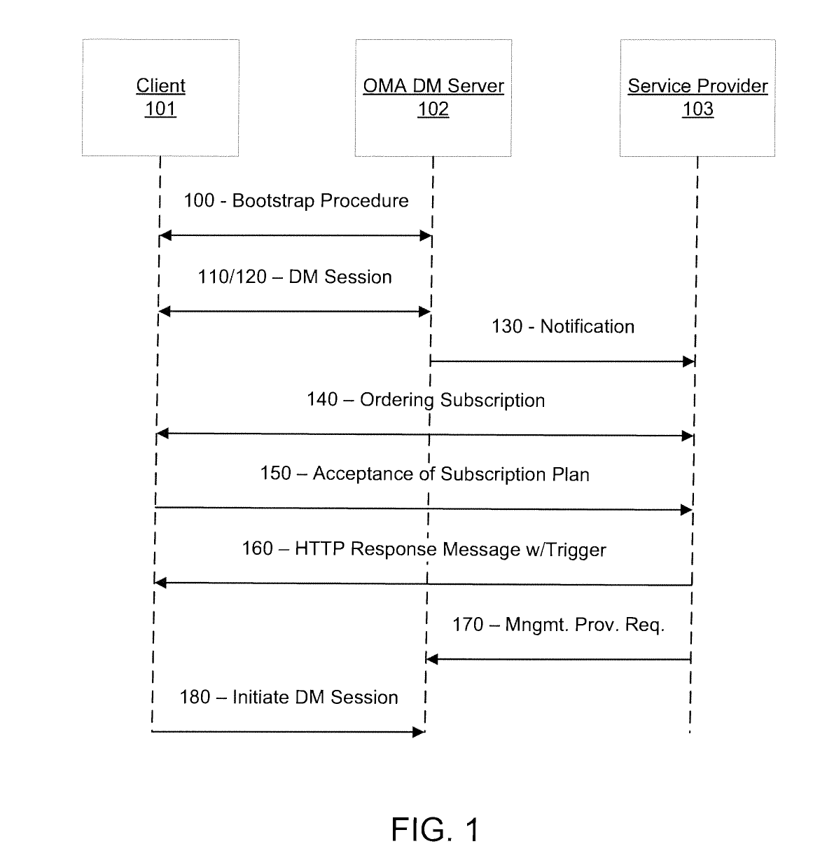

FIG. 1 is a flow chart showing an exemplary implementation of various embodiments. More particularly, FIG. 1 shows a signaling diagram illustrating exemplary signaling between the OMA DM client 101, the OMA DM server 102, and the service provider node 103. At 100 of FIG. 1, a client-initiated bootstrap procedure is performed between the OMA DM client 101 and the OMA DM server 102. This bootstrap procedure is performed to provision the OMA DM client 101 with the required settings to initiate a session with a specific OMA DM server 102. The bootstrap procedure is used to establish a security association between the OMA DM client 101 and the provisioning OMA DM server 102 in order to initiate a management session. Once the bootstrap procedure has been successfully executed, a secure path between the OMA DM client 101 and the OMA DM server 102 may be established and the provisioning process for the OMA DM client 101 may begin. At 110, upon completion of the client-initiated bootstrap procedure, the OMA DM client 101 may initiate a DM session with the OMA DM server 102. During this DM session, the OMA DM client 101 may send a package to the OMA DM server 102 including credentials and information about the client or associated device. At 120, during the same DM session, the OMA DM server 102 may query the OMA DM client 101 to obtain capability information (e.g., WiMAX/DevCAP). Upon completion of this querying process, the DM session is concluded. At 130, the OMA DM server 102 sends a notification to a service provider node 103. The notification may comprise the device information, the device capabilities, and a bootstrap method flag. As described herein, the service provider node 103 may be a subscription portal, a service provider subscription portal subsystem, a policy server, or similar structures.

At 140, the service provider node 103 begins conducting an ordering subscription procedure with the OMA DM client 101. This procedure may be conducted via HTTP or Hypertext Transfer Protocol over Secure Socket Layer (HTTPS), wherein one or more requests and response messages are exchanged between the service provider node 103 and the OMA DM client 101. During this process, the user of the device or OMA DM client 101 may communicate with the service provider node 103 to create a business relationship and a user account. The user account information may be stored by the service provider in a database (not shown) for possible access by a the OMA DM server 102 or for access by an authentication, authorization, and accounting (AAA) node (not shown). At 150, the user of the device or OMA DM client 101 may accept a subscription plan and communicate this acceptance to the service provider node 103.

At 160, in response to receiving an indication that the user has accepted a subscription plan, the service provider node 103 creates a last or final HTTP (or HTTPS) response message to transmit to the device associated with the OMA DM client 101. Within this final HTTP response message, the service provider node 103 is configured to include an indicator which triggers the OMA DM client 101 to initiate a DM session with the OMA DM server 102. The indicator may include a number of retry connections and/or polling timers. The indicator may be included in the header of the HTTP response message. As one skilled in the art would understand, a HTTP response header includes a plurality of fields. For example, a HTTP response header may include one or more of the following fields: Status, Date, Connection, Server, Accept-Ranges, Content-Type, Content Length, Last-Modified, Age, ETag, Location, Proxy-Authenticate, Retry-After, Vary, and WWW-Authenticate. It should be noted that this list is not exhaustive and other types of header fields may be included in the HTTP response header.

In various embodiments, the service provider node 103 may include the triggering indicator in the Content-Type field of the HTTP response header. For example, the Content-Type header of the HTTP response may include a Multipurpose Internet Mail Extension (MIME) media type for OMA DM Package #0 (application/vnd.syncml.notification), as defined in Internet Assigned Numbering Authority (LANA) for OMA DM notifications. Alternatively, the service provider node 103 may include the triggering indicator in a different HTTP header field within the HTTP response message. In either case, the HTTP response message header, which is sent from the service provider node 103 to the device associated with the OMA DM client 101, includes an indicator to trigger the OMA DM client 101 to initiate a DM session with the OMA DM server 102 upon reception. It should be noted that the indicator is not limited to being sent in the last or final HTTP response message sent from the service provider node 103. Instead, the indicator may be included in a previous response message sent from the service provider node 103.

At 170, the service provider node 103 provides a management provision request to the OMA DM server 102. The request may include the device credentials, the user credentials, and mobile station ID (MSID). It should be noted that this process may be conducted in parallel with or at an earlier time than the process depicted at 160.

At 180, in response to receiving the above-discussed HTTP response message, the OMA DM client 101 is triggered to initiate a new DM session between the OMA DM client 101 and the OMA DM server 102. During this new DM session, the OMA DM server 102 may transfer initial provisioning information to the OMA DM client 101.

Accordingly, various embodiments enable a service provider node 103 to trigger an OMA DM client 101 to initiate a DM session. More specifically, various embodiments provide a specified trigger within a HTTP response header which, when received by the device associated with the OMA DM client 101, causes to OMA DM client 101 to initiate a DM session. As such, various embodiments provide a triggering mechanism for OMA DM clients 101 which only support WM.

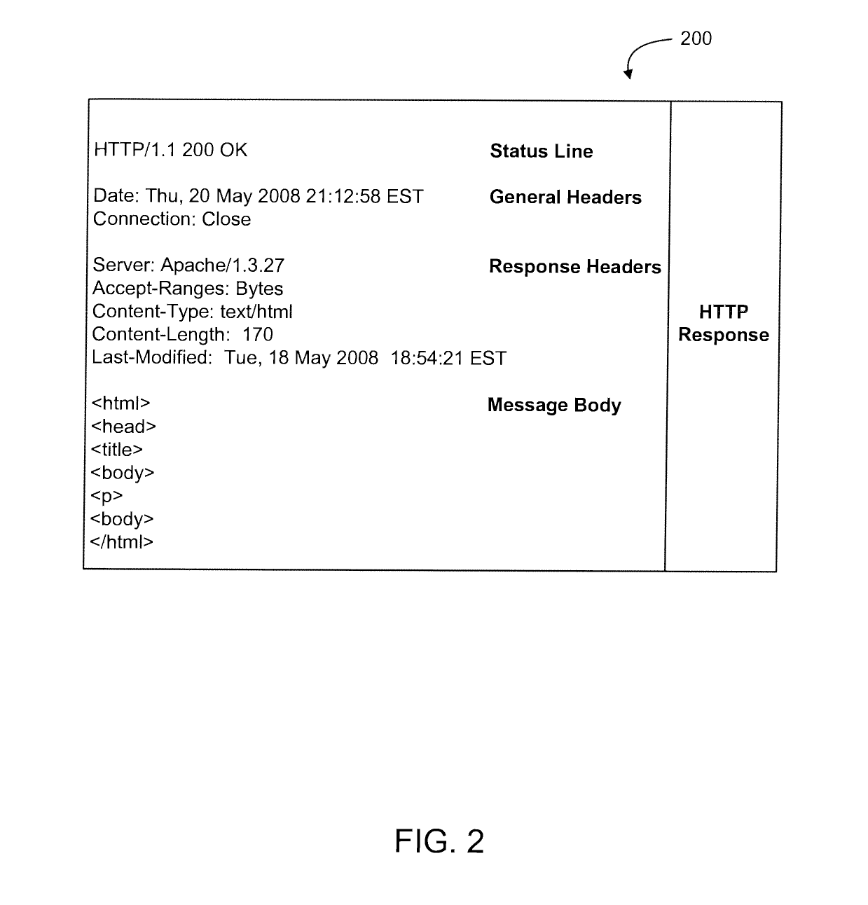

FIG. 2 shows an exemplary HTTP Response message 200. As discussed above, the triggering indicator may be included in the header of the HTTP Response message. For example, the triggering indicator may be included in the Content-Type header field. Alternatively, the triggering indicator may be included in a different field within the HTTP response message. In addition, the indicator may be included in the message body of the HTTP response message. For example, the indicator may be included in the response data within the message body.

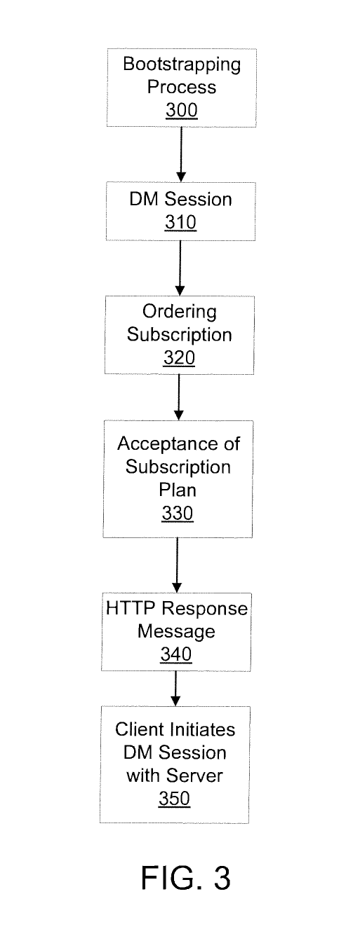

FIG. 3 is a flow chart illustrating an exemplary implementation of various embodiments. At 300, a bootstrapping procedure is conducted between the OMA DM client 101 of a user terminal and the OMA DM server 102. At 310, upon completion of the bootstrapping process, a DM session is established between the OMA DM client 101 and the OMA DM server 102. At 320, upon completion of the DM session, an ordering subscription procedure is conducted between the OMA DM client 101 and a service provider node 103. At 330, the service provider node 103 receives an acceptance message from the OMA DM client 101. At 340, the service provider node 103 sends a HTTP response message to the device associated with the OMA DM client 101. Within the HTTP response message, the service provider node 103 includes an indicator which triggers the OMA DM client 101 to initiate a DM session with the OMA DM server 102. The indicator may be included in the header of the HTTP response message. In various embodiments, the service provider node 103 may include the indicator in the Content-Type field of the HTTP response header. For example, the Content-Type header of the HTTP response may include a MIME media type for OMA DM Package #0 (application/vnd.syncml.notification), as defined in LANA for OMA DM notifications. Alternatively, the service provider node 103 may include the indicator in a different HTTP header field within the HTTP response message or in the message body of the HTTP response message. In either case, the HTTP response message, which is sent from the service provider node 103 to the OMA DM client 101, includes an indicator to trigger the OMA DM client 101 to initiate a DM session upon reception. At 350, the OMA DM client 101 initiates a DM session with the OMA DM server 102 and receives initial provisioning data from the OMA DM server 102.

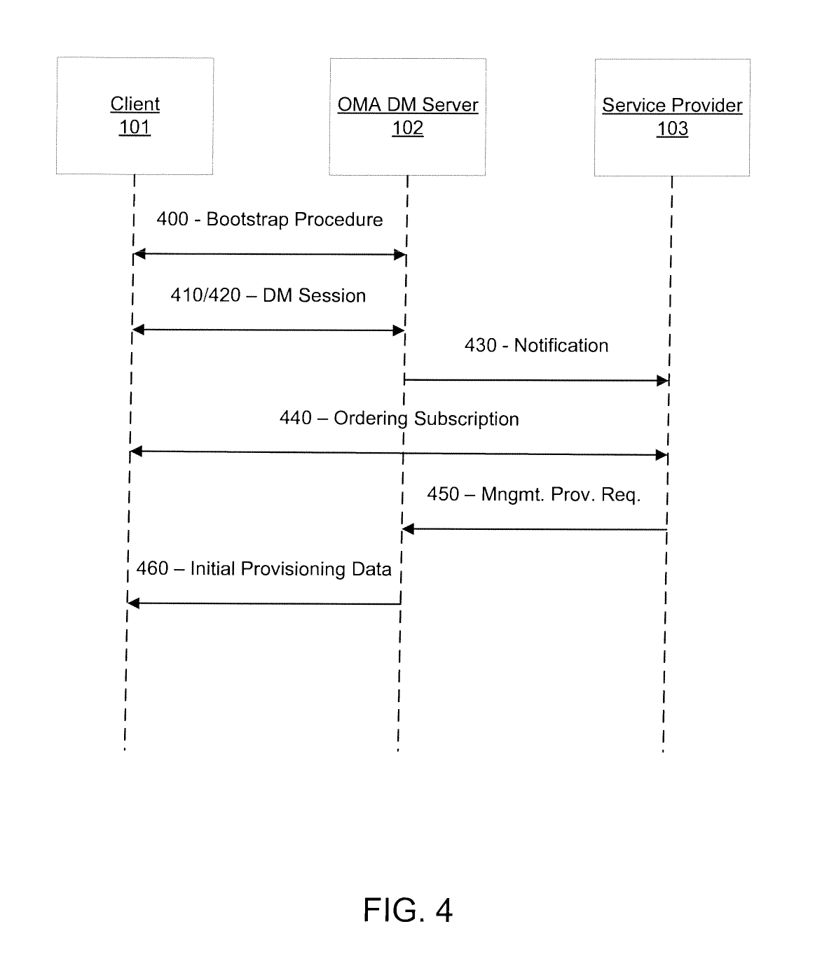

FIG. 4 is a flow chart illustrating exemplary implementations of various other embodiments. More particularly, FIG. 4 shows a signaling diagram illustrating an alternate embodiment for providing initial provisioning information in a DM session between a OMA DM server 102 and a OMA DM client 101. The signaling diagram illustrates signaling between the OMA DM client 101, the OMA DM server 102, and the service provider node 103. In this embodiments, processes 400-420 are substantially identical to that of processes 100-120. However, the DM session 420 between the OMA DM client 101 and the OMA DM server 102 is maintained after the device capabilities query is concluded between the OMA DM server 102 and the OMA DM client 101. Therefore, at 430, while still maintaining a DM session with the OMA DM client 101, the OMA DM server 102 sends a notification to the service provider node 103. The notification may comprise, for example, device information, device capabilities information, and a bootstrap method flag. At 440, the service provider node 103 conducts an ordering subscription process with the OMA DM client 101. At 450, upon completion of the subscription ordering processes, the service provider node 103 sends a management provision request to the OMA DM server 102. At 460, the OMA DM server 103 sends initial provisioning data to the OMA DM client 101 via the DM session previously created between the OMA DM client 101 and the OMA DM server 102. As such, the initial provisioning data may be sent from the OMA DM server 102 to the OMA DM client 101 without requiring a UDP PUSH message and without requiring a new DM session.

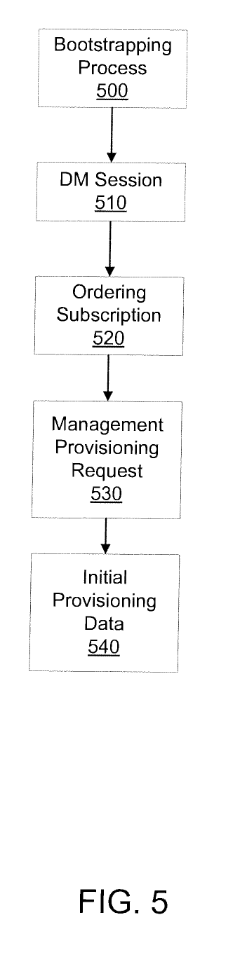

FIG. 5 is a flow chart illustrating an exemplary implementation of various embodiments of the present application. At 500, a bootstrapping procedure is conducted between the OMA DM client 101 of a user terminal and the OMA DM server 102. At 510, upon completion of the bootstrapping process, a DM session is established between the OMA DM client 101 and the OMA DM server 102 to exchange device and client information. This DM session is maintained upon completion of this process. At 520, an ordering subscription procedure is conducted between the OMA DM client 101 and a service provider node 103. At 530, the service provider node 103 sends a management provisioning request to the OMA DM server 102. At 540, the OMA DM server 102 sends initial provisioning data to the OMA DM client 101 via the same DM session previously established between the OMA client 101 and the OMA DM server 102.

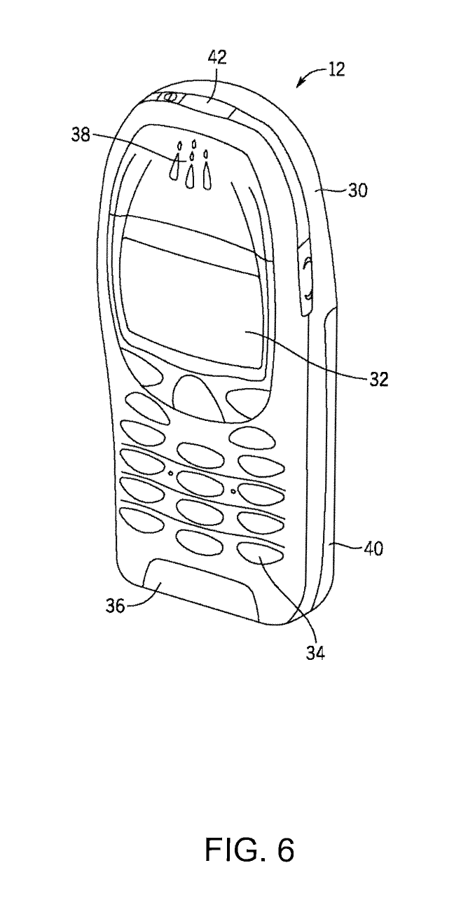

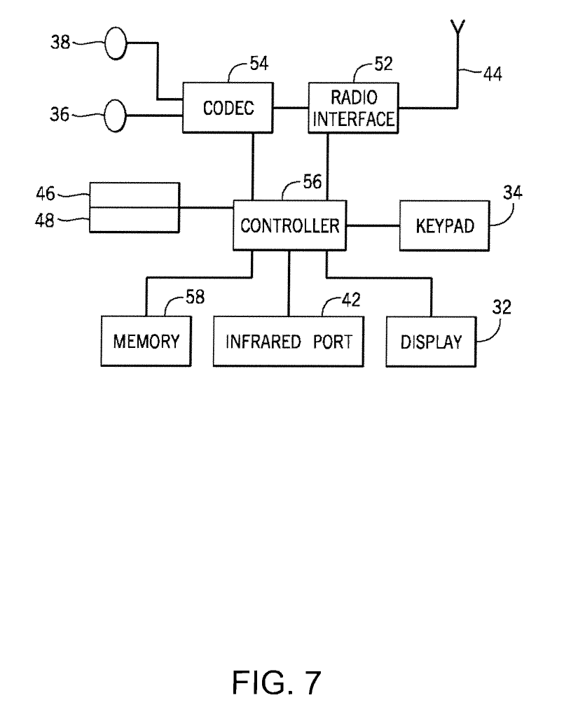

FIGS. 6 and 7 show one representative device 12 or user terminal associated with the OMA DM client 101 within which various embodiments may be implemented. It should be understood, however, that the present invention is not intended to be limited to one particular type of device. The electronic device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving, at a service provider node, an acceptance message concerning an acceptance of a subscription plan from a user terminal associated with the service provider node, the acceptance message concluding an ordering subscription procedure conducted between the service provider node and the user terminal;
creating, in response to the received acceptance message, a response message including a predetermined identifier in the response message, the predetermined identifier configured to trigger an initiation action by the user terminal upon receipt and subsequent processing by the user terminal; and
transmitting, from the service provider node to the user terminal, the response message including the predetermined identifier in the response message.

2. An apparatus, comprising:
a processor;
memory including computer program code, the memory and the computer program code configured to, working with the processor, cause the apparatus to perform at least the following:
receive an acceptance message concerning an acceptance of a subscription plan from a user terminal, the acceptance message concluding an ordering subscription procedure conducted with the user terminal;
create, in response to the received acceptance message, a response message including a predetermined identifier in the response message, the predetermined identifier configured to trigger an initiation action by the user terminal upon receipt and subsequent processing by the user terminal; and
transmit, to the user terminal, the response message including the predetermined identifier in the response message.

3. The apparatus of claim 2, wherein the acceptance message received from the user terminal comprises a final Hypertext Transfer Protocol (HTTP) message sent from the user terminal after acceptance of the subscription plan.

4. The apparatus of claim 2, wherein the response messages comprises a Hypertext Transfer Protocol response message.

5. The apparatus of claim 2, wherein the predetermined identifier is included in at least one of:
a header portion of the Hypertext Transfer Protocol response message,
a content-type field in a header portion of the Hypertext Transfer Protocol response message, and
a predetermined field in a header portion of the Hypertext Transfer Protocol response message.

6. The apparatus of claim 2, wherein apparatus comprises a subscription portal.

7. The apparatus of claim 2, wherein the response message is configured to cause the user terminal to initiate a device management session with a device management server and thereby receive initial provisioning information from the device management server.

8. The apparatus of claim 2, wherein the user terminal does not support user data protocol PUSH messaging.

9. The apparatus of claim 2, wherein the predetermined identifier comprises at least one of a number of retry connections and a polling timer.

10. A method, comprising:
transmitting, from a user terminal, an acceptance message concerning a subscription plan to a service provider node, the acceptance message concluding an ordering subscription procedure being conducted between the service provider node and the user terminal;
receiving, from the service provider node, a response message comprising a predetermined identifier in the response message, the predetermined identifier configured to
trigger an initiation action by the user terminal upon receipt and subsequent processing by the user terminal; and
initiating, in response to receipt and subsequent processing of the predetermined identifier within the response message, a management session with a server.

11. An apparatus, comprising:
a processor
memory including computer program code
the memory and the computer program code configured to, working with the processor, cause the apparatus to perform at least the following:
transmit an acceptance message concerning a subscription plan to a service provider, the acceptance message concluding an ordering subscription procedure being conducted with the service provider node;
receive, from the service provider node, a response message comprising a predetermined identifier in the response message, the predetermined identifier configured to trigger an initiation action; and
initiate, in response to receipt and subsequent processing of the predetermined identifier within the response message, a management session with a server.

12. The apparatus of claim 11, wherein the response message comprises a Hypertext Transfer Protocol response message.

13. The apparatus of claim 12, wherein the predetermined identifier is included in at least one of a:
header portion of the Hypertext Transfer Protocol response message;
a content-type field in a header portion of the Hypertext Transfer Protocol response message; or.
a predetermined field in a header portion of the Hypertext Transfer Protocol response message.

14. The apparatus of claim 11, wherein the service provider node comprises a subscription portal.

15. The apparatus of claim 11, wherein the electronic device is further configured to receive initial provisioning information from the server.

16. The apparatus of claim 11, wherein the electronic device does not support User Data Protocol (UDP) PUSH messaging.

17. The apparatus of claim 11, wherein the predetermined identifier comprises at least one of a number of retry connections and a polling timer.

18. A method, comprising:
conducting a client-initiated bootstrap procedure with a user terminal;
querying the user terminal for user terminal information in a device management session;
maintaining the device management session with the user terminal after completion of the query;
providing the user terminal information to a service provider node;
receiving a management provision request from the service provider node; and
sending initial provisioning data to the user terminal using the device management session.

19. An apparatus, comprising:
a processor;
memory including computer program code, the memory and the computer program code configured to, working with the processor, cause the apparatus to perform at least the following:
conduct a client-initiated bootstrap procedure with a user terminal;
query the user terminal for user terminal information in a device management session;
maintain the device management session with the user terminal after completion of the query;
provide the user terminal information to a service provider node;
receive a management provision request from the service provider node; and
send initial provisioning data to the user terminal using the device management session.

20. The apparatus of claim 19, wherein the processes are performed by a device management server.

21. The apparatus of claim 19, wherein the service provider node comprises a subscription portal.

22. The apparatus of claim 19, wherein the user terminal does not support user data protocol PUSH messaging.

23. The apparatus of claim 19, wherein the user terminal only supports WiMAX Specific Client-Initiated Bootstrap.
